(19) United States
(12) Patent Application Publication
(10) Pub. No.: US 2026/0276302 A1
(43) Pub. Date: Sep. 17, 2026

(54) MULTI-MODAL DRYING APPARATUS

(71) Applicant: Abhiram Rachamadugu, Bengaluru (IN)

(72) Inventor: Abhiram Rachamadugu, Bengaluru (IN)

(21) Appl. No.: 19/238,480

(22) Filed: Jun. 15, 2025

(30) Foreign Application Priority Data
Mar. 13, 2025 (IN) 202541022921

(51) Int. Cl. F26B 3/28; F26B 23/02; F26B 25/18

(52) U.S. Cl. CPC F26B 3/286; F26B 23/028; F26B 25/185

(57) ABSTRACT

A multi-modal drying apparatus (100) includes a first chamber (102). The first chamber (102) includes a base member (202), a first cover (208) covering the base member (202), a first air vent (108) provided at first end (104) of the first chamber (102), and a second air vent (110) provided at a second end (106) of the first chamber (102). The multi-modal drying apparatus (100) also includes a second chamber (112) in fluidic communication with the first chamber (102) through the second air vent (110). The second chamber (112) includes at least one slab (302) configured to receive an item (304) for drying, thereupon. The base member (202) is configured to absorb heat energy from solar radiation (402) and transfer the absorbed heat energy to air entering the first chamber (102) from the first air vent (108) and exiting the first chamber (102) from the second air vent (110).

### TECHNICAL FIELD

The present disclosure relates generally to dryers and apparatuses used for the removal of moisture and heating items for several different purposes, more particularly, the present disclosure relates to drying apparatuses that are used to desiccate perishable items, using more than one mode for the provision of heat energy.

### BACKGROUND

The Food and Agricultural Organization (FAO) reports a staggering statistic: nearly 40% of the food produced in India is wasted annually. This alarming figure underscores a critical issue with profound social and economic consequences. Contributing factors to this food waste are multifaceted. Inefficient supply chains, characterized by poor infrastructure and inadequate cold storage facilities, lead to significant post-harvest losses. Volatile market prices for agricultural produce can render harvests unprofitable, discouraging farmers from investing in proper storage and leading to spoilage. Moreover, unpredictable weather patterns, including erratic rainfall and extreme temperatures, can devastate crops and further exacerbate food losses. The inadequate development of food-processing infrastructure within the country also plays a crucial role.

This situation is particularly alarming given the high prevalence of malnutrition in India, where nearly 45% of children suffer from under nutrition. Wasting vast quantities of food while a significant portion of the population struggles with hunger is a stark irony in the current system. Food preservation methods offer a potential solution to mitigate these losses. Traditional methods like salting and pickling, while effective, present several challenges. These methods often require additional resources, such as salt and vinegar, which can be costly for small-scale farmers. Furthermore, salting and pickling significantly alter the taste and texture of the produce, limiting its versatility and marketability. The extra processing steps associated with these methods can also increase production costs, further burdening small-scale farmers with limited resources.

Drying emerges as a more promising and sustainable option for food preservation in India. It is generally a low-cost method that requires minimal resources and can be adapted to various types of produce. However, traditional open-air sun drying, while energy-free, presents several drawbacks. Hygiene concerns arise due to exposure to dust and contaminants. Additionally, prolonged exposure to sunlight can lead to significant color and nutrient loss, particularly due to the degradation of vitamins and antioxidants by ultraviolet (UV) radiation.

Effective drying necessitates a combination of factors: heated air to accelerate the process, low humidity to prevent microbial growth, and good airflow to facilitate moisture removal. While several solar dryer designs are available, their high cost and maintenance requirements often pose significant barriers for small and marginal farmers. Therefore, there is a need in the art of a multi-modal drying apparatus that addresses at least some of the concerns listed above.

### SUMMARY

Various embodiments of the present disclosure provide a multi-modal drying apparatus. The multi-modal drying apparatus includes a first chamber. The first chamber includes a base member, a first cover covering the base member, a first air vent provided at a first end of the first chamber, and a second air vent provided at a second end of the first chamber. The multi-modal drying apparatus further includes a second chamber in fluidic communication with the first chamber through the second air vent. The second chamber includes at least one slab configured to receive an item for drying, thereupon. The base member is configured to absorb heat energy from solar radiation and transfer the absorbed heat energy to air entering the first chamber from the first air vent and exiting the first chamber from the second air vent. Also, the at least one slab is configured to enable drying of the item by the air entering the second chamber from the second air vent.

In one embodiment, the base member is made from a thermal absorption material. Thermal absorption materials have high thermal conductivities, emissivity, and specific heat capacities, allowing thermal absorption materials to absorb large amount of thermal energy from solar radiation and then release the absorbed thermal energy gradually for long durations to other media, such as recirculating air, through conduction, convection, and/or radiation.

In one embodiment, the thermal absorption material includes black limestone. Black limestone is a relatively economical material widely available in many rural areas. Therefore, the use of black limestone allows significant cost savings.

In one embodiment, the top surface of the base member is inclined at a predetermined angle with respect to ground surface, to maximize absorption of the heat energy by the base member from the solar radiation. The predetermined angle may be a fixed angle based on the geographical coordinates of a location where the multi-modal drying apparatus may be located. Alternately, the predetermined angle may be variable through the use of actuators to track the movement of the sun during the course of the day.

In one embodiment, the multi-modal drying apparatus further includes a plurality of baffles provided on a top surface of the base member, wherein the plurality of baffles is located between the first cover and the base member. The baffles force the air entering from the first air vent to spend extended time in the first chamber allowing sufficient amount of heat energy to be transferred from the base member to the air in the first chamber.

In one embodiment, the first cover includes transparent glass material. The transparent glass has the property of trapping reflected radiation with longer wavelengths, forcing the thermal energy of the solar radiation to be trapped within the first chamber with minimal losses.

In one embodiment, the second chamber includes a second cover covering the at least one slab. Furthermore, the second cover includes a chimney configured to discharge the air to ambient.

In one embodiment, the at least one slab includes a plurality of apertures configured to enable the air to circulate within the second chamber.

In one embodiment, the multi-modal drying apparatus further includes a third chamber provided under the second chamber. The second chamber is separated from the third chamber by a separating member. The third chamber is configured to enable combustion of a fuel therein, to generate the heat energy, and the separating member is configured to transfer the generated heat energy to the air inside the second chamber. The third chamber acts as an additional source of heat energy especially to compensate for the loss of solar energy during evenings or overcast conditions.

In one embodiment, the third chamber includes an exhaust vent configured to release to ambient, at least a part of combustion products generated from the combustion of the fuel. The exhaust vent prevents a build-up of soot or other combustion products within the third chamber ensuring the longevity of the multi-modal drying apparatus.

### BRIEF DESCRIPTION OF THE FIGURES

For a more complete understanding of example embodiments of the present technology, reference is now made to the following descriptions taken in connection with the accompanying drawings:

FIG. 1 illustrates a front-perspective view of a multi-modal drying apparatus, in accordance with an embodiment of the present disclosure;

FIG. 2 illustrates a partially exploded view of the multi-modal drying apparatus, in accordance with an embodiment of the present disclosure;

FIG. 3 illustrates a rear view of the multi-modal drying apparatus, in accordance with an embodiment of the present disclosure; and

FIG. 4 illustrates a working principle of the multi-modal drying apparatus, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

Various example embodiments of the present disclosure provide a multi-modal drying apparatus including multiple chambers designed to facilitate drying through solar and combustion-generated heat. A first chamber features a base member, a first cover, and air vents on either end, allowing air to flow through. The base member absorbs solar heat and transfers the absorbed solar heat to the air passing through the first chamber. A second chamber connects to the first chamber via an air vent and includes a slab for drying items. The heated air from the first chamber enters the second chamber, enabling drying.

The base member is constructed from a thermal absorption material, such as black limestone, and a top surface of the base member is inclined to optimize heat absorption from solar radiation. Baffles positioned on the base member beneath the first cover enhance the heat transfer process. The first cover may include transparent glass. The second chamber is equipped with a cover that includes a chimney for air discharge and the slab is provided with apertures to promote air circulation.

An additional third chamber beneath the second chamber enables the combustion of fuel to generate heat. A separating member transfers this heat to the air in the second chamber, supplementing the solar heating process. The third chamber also includes an exhaust vent for releasing combustion byproducts to the environment.

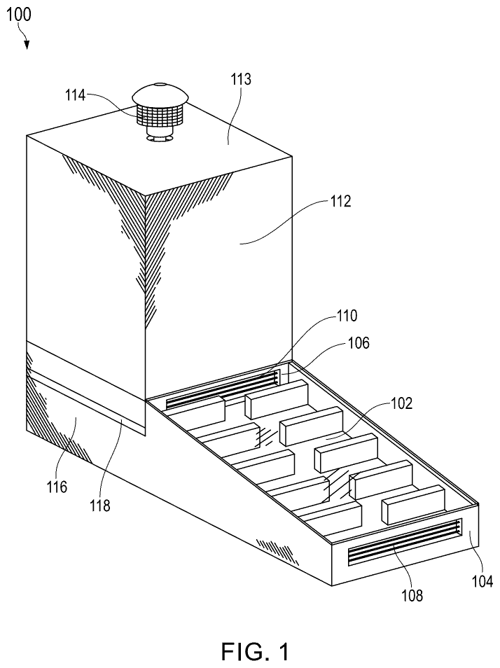

Various example embodiments of the present disclosure are described hereinafter with reference to FIG. 1 to FIG. 4.

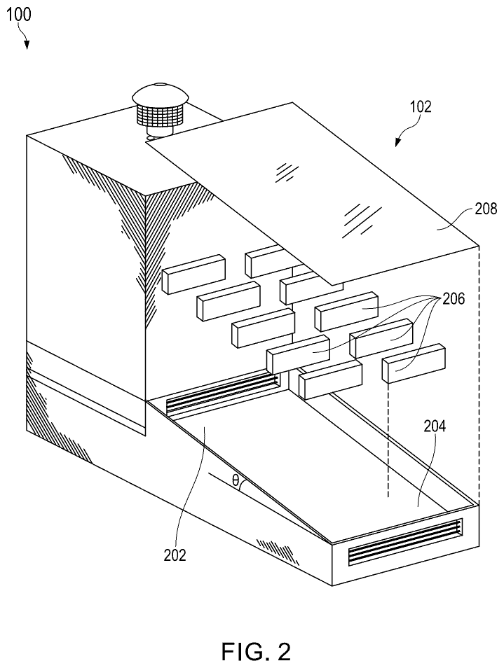

FIG. 1 illustrates a front perspective view of a multi-modal drying apparatus (100) (hereinafter also referred to as “the apparatus (100)”), in accordance with an embodiment of the present disclosure. The apparatus (100) includes a first chamber (102). The first chamber (102) includes a first end (104) located in a front portion of the first chamber (102). Furthermore, the first chamber (102) includes a second end (106) located in a rear portion of the first chamber (102). A first air vent (108) has been provided at the first end (104) for entry of air into the first chamber (102). Furthermore, a second air vent (110) has been provided at the second end (106) for the air to exit the first chamber (102). The first chamber (102) may partially be made up of bricks and mortar, or concrete blocks. For example, sidewalls of the first chamber (102) may be made up of bricks and mortar, or concrete blocks. A first cover (See FIG. 2) in an upper portion of the first chamber (102).

The apparatus (100) further includes a second chamber (112) in fluidic communication with the first chamber (102). The second chamber (112) is in fluidic communication with the first chamber (102) through the second air vent (110). In other words, the air exiting the first chamber (102) would directly enter the second chamber (112) through the second air vent (110). In that regard, the second chamber (112) is a hollow chamber. The second chamber (112) may be substantially made up of bricks and mortar, or concrete blocks. For example, a rear door (not shown) may be provided with the second chamber (112) for accessing the contents of the second chamber (112) as will be discussed in the following discussion. In that regard, the rear door may be made up of wooden or plastic material.

The second chamber (112) includes a second cover (113) for covering the contents of the second chamber (112). The second cover (113) may be made up of stone, bricks and mortar, concrete blocks, or any other rigid material depending upon availability and design requirements. The second cover (113) includes a chimney (114) configured to discharge to the ambient, the air entering from the second air vent (110). The apparatus (100) further includes a third chamber (116) provided under the second chamber (112). The construction of the third chamber (116) may be similar to the construction of the second chamber (112). A separating member (118) separates the third chamber (116) from the second chamber (112).

It is envisaged that the separating member (118) may be made up of a thermal absorption material. A thermal absorption material is a substance specifically designed to efficiently absorb heat from solar radiation and then later release the heat to other media through conduction, convection, and/or radiation. Thermal absorption materials possess a high thermal conductivity, specific heat capacity, and density to efficiently absorb thermal radiation from the sun or other heat sources. Additionally, the high thermal conductivity allows the thermal absorption material to effectively transfer heat from a heat source to a radiator surface. The durability of the thermal absorption materials allows them to withstand the harsh environments the thermal absorption materials often encounter. The harsh environments may include extreme temperatures, humidity, and radiation. However, in several alternate embodiments, the separating member (118) may be made up of concrete. Concrete can absorb large amount of heat during the heating period and then release the heat gradually when temperatures in the surroundings are relatively lower.

FIG. 2 illustrates a partially exploded view of the multi-modal drying apparatus (100), in accordance with an embodiment of the present disclosure. More specifically, FIG. 2 illustrates the exploded view of the first chamber (102). The first chamber (102) includes a base member (202). The base member (202) is configured to absorb heat energy from solar radiation and transfer the absorbed heat energy to the air entering the first chamber (102) from the first air vent (108). In that regard, the base member (202) may also be made up of a thermal absorption material. In several embodiments, the base member (202) may be made up of black limestone. The use of black limestone as the base member (202) has significant advantages. For instance, black limestone is widely available in rural areas and is relatively economical to procure allowing significant cost savings for a user constructing the apparatus (100). However, in several alternate embodiments, the base member (202) may be at least partially made up of concrete slab painted black, or any other local stone or local material painted black.

Furthermore, to maximize the absorption of the heat energy by the base member (202) from solar radiation, the base member (202) has been inclined at a predetermined angle (θ) with respect to the ground surface. In several embodiments, the predetermined angle (θ) may be a fixed tilt angle and may be determined in correlation with the latitude, longitude, and/or altitude of the location where the apparatus (100) has been installed. In several alternate embodiments, the base member (202) may be provided with a hand-operated or automated motorized mechanism that may modify the predetermined angle (θ). The predetermined angle (θ) may be modified in correlation with the position of the sun in the sky during daytime and/or a particular season of the year.

Furthermore, the base member (202) has a top surface (204) exposed upwards. A plurality of baffles (206) has been provided on the top surface (204). The plurality of baffles (206) may be attached to the side surfaces of the first chamber (102) in an alternating manner. The plurality of baffles (206) is configured to impede the flow of air between the first air vent (108) and the second air vent (110) enabling the air to spend a relatively longer period within the first chamber (102). The longer time the air spends in the first chamber (102) in proximity to the base member (202), the more heat would be absorbed by the air from the base member (202). A first cover (208) covers the base member (202) and the plurality of baffles (206). The first cover (208) is configured to prevent heat energy from escaping the first chamber (102). In several embodiments, the first cover (208) includes transparent glass material. The transparent glass material has the property to create a greenhouse effect where Infrared (IR) radiation emitted by the sun with relatively shorter wave length scan pass through the first cover (208) and into the first chamber (102). However, after the IR radiation is absorbed and reflected from the base member (202), radiation would have relatively longer wavelengths and would not be able to pass through the first cover (208), trapping the heat energy from the solar radiation within the first chamber (102). After the air has been heated in the first chamber (102), the heated air would be directed towards the second chamber (112) through the second vent (110).

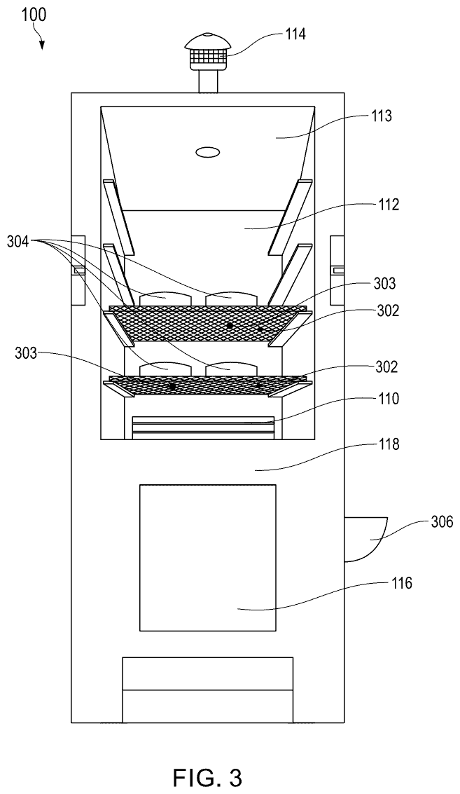

FIG. 3 illustrates a rear view of the multi-modal drying apparatus (100), in accordance with an embodiment of the present disclosure. FIG. 3 illustrates an open-door view of the second chamber (112) and the third chamber (116). The second chamber (112) includes at least one slab (302) (two slabs (302) have been shown in FIG. 3). The at least one slab (302) is configured to receive, thereupon, items (304) for drying. The items (304) may be perishable items such as farm produce, cooked meals, bread, flowers, plants, etc. The second air vent (110) is located below the at least one slab (302). As heated air would enter the second chamber (112) from the second air vent (110), the heated air would rise upwards and toward the items (304) kept upon the at least one slab (302).

In that regard, the at least one slab (302) may be provided with a plurality of apertures (303) configured to enable the air to circulate within the second chamber (112). For example, the at least one slab (302) in FIG. 3 have been shown as a wire-meshed structure. In several alternate embodiments, the at least one slab (302) may include through holes drilled into a solid plate. In several additional embodiments, the at least one slab (302) may be a concrete mesh, and made up of a thermally conducting material to absorb heat from the heated air and enable drying of the items (304) kept thereupon.

The third chamber (116) is configured to enable combustion of a fuel therein to generate heat. The third chamber (116) may be utilized when sufficient heat is not available from solar radiation, such as during nighttime or overcast conditions. The third chamber (116) may be used to burn biomass as fuel or may be supplied with other forms of gaseous or liquid fuels with necessary safety arrangements. The heat generated by the combustion of the fuel in the third chamber (116) may be transferred to the air inside the second chamber (112) through the separating member (118). In several embodiments, the third chamber (116) may also include an exhaust vent (306) configured to release to the ambient, at least a part of the combustion products generated from the combustion of the fuel in the third chamber (116).

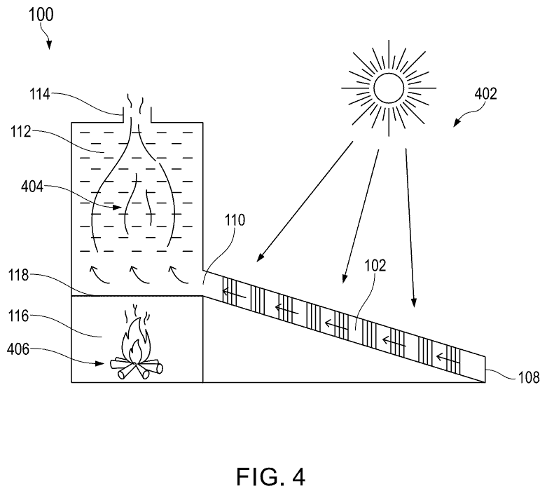

FIG. 4 illustrates a working principle of the multi-modal drying apparatus (100), in accordance with an embodiment of the present disclosure. FIG. 4 illustrates at least two modalities for drying items (304) in the second chamber (112). In a first modality, ambient air may enter the first chamber (102) through the first air vent (108). The base member (202) may absorb heat energy from solar radiation (402). The plurality of baffles (206) would impede the flow of air in the first chamber (102) allowing the air to absorb the heat energy from the base member (202). The heated air (404) would then enter the second chamber (112) through the second air vent (110) and rise upwards because of being at a higher temperature. While rising upwards the heated air (404) would dry the items (304) kept on the at least one slab (302) in the second chamber (112). The heated air (404) would then be discharged to the ambient through the chimney (114).

In a second modality, when solar energy is absent or inadequate, fuel (406) such as biomass may be combusted in the third chamber (116). The heat generated by the combustion of the fuel (406) may be transferred to air inside the second chamber (112) through the separating member (118). As the air inside the second chamber (112) is heated, the heated air (404) would rise upwards and dry the items (304) kept on the at least one slab (302) in the second chamber (112). The heated air (404) would then be discharged to the ambient through the chimney (114).

Various embodiments of the invention, as discussed above, may be practiced with steps and/or operations in a different order, and/or with hardware elements in configurations, which are different from those which, are disclosed. Therefore, although the invention has been described based on these exemplary embodiments, It is to be noted that certain modifications, variations, and alternative constructions may be apparent and well within the scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

I/We claim:

1. A multi-modal drying apparatus (100), comprising:
a first chamber (102) comprising:
a base member (202),
a first cover (208) covering the base member (202),
a first air vent (108) provided at first end (104) of the first chamber (102), and
a second air vent (110) provided at a second end (106) of the first chamber (102); and
a second chamber (112) in fluidic communication with the first chamber (102) through the second air vent (110), the second chamber (112) comprising at least one slab (302) configured to receive an item (304) for drying, thereupon,
wherein the base member (202) is configured to absorb heat energy from solar radiation (402) and transfer the absorbed heat energy to air entering the first chamber (102) from the first air vent (108) and exiting the first chamber (102) from the second air vent (110), and
wherein the at least one slab (302) is configured to enable drying of the item (304) by the air entering the second chamber (112) from the second air vent (110).

2. The multi-modal drying apparatus (100) as claimed in claim 1, wherein the base member (202) is made from a thermal absorption material.

3. The multi-modal drying apparatus (100) as claimed in claim 2, wherein the thermal absorption material comprises black limestone.

4. The multi-modal drying apparatus (100) as claimed in claim 1, wherein the top surface (204) of the base member (202) is inclined at a predetermined angle (θ) with respect to ground surface, to maximize absorption of the heat energy by the base member (202) from the solar radiation (402).

5. The multi-modal drying apparatus (100) as claimed in claim 1, further comprising a plurality of baffles (206) provided on a top surface (204) of the base member (202), wherein the plurality of baffles (206) is located between the first cover (208) and the base member (202).

6. The multi-modal drying apparatus (100) as claimed in claim 1, wherein the first cover (208) comprises a transparent glass material.

7. The multi-modal drying apparatus (100) as claimed in claim 1, wherein the second chamber (112) comprises a second cover (113) covering the at least one slab (302), wherein the second cover (113) comprises a chimney (114) configured to discharge the air to ambient.

8. The multi-modal drying apparatus (100) as claimed in claim 1, wherein the at least one slab (302) comprises a plurality of apertures (303) configured to enable the air to circulate within the second chamber (112).

9. The multi-modal drying apparatus (100) as claimed in claim 1, further comprising a third chamber (116) provided under the second chamber (112), the second chamber (112) separated from the third chamber (116) by a separating member (118), wherein the third chamber (116) is configured to enable combustion of a fuel (406) therein, to generate the heat energy, and the separating member (118) is configured to transfer the generated heat energy to the air inside the second chamber (112).

10. The multi-modal drying apparatus (100) as claimed in claim 8, wherein the third chamber (116) comprises an exhaust vent (306) configured to release to ambient, at least a part of combustion products generated from the combustion of the fuel (406).
